(19) United States
(12) Patent Application Publication
(10) Pub. No.: US 2012/0109821 A1
(43) Pub. Date: May 3, 2012

(54) SYSTEM, METHOD AND COMPUTER PROGRAM PRODUCT FOR REAL-TIME ONLINE TRANSACTION RISK AND FRAUD ANALYTICS AND MANAGEMENT

(76) Inventors: Jesse Barbour, Austin, TX (US); Adam D. Anderson, Austin, TX (US); Robert Henry Seale, III, Dripping Springs, TX (US)

(21) Appl. No.: 12/916,210

(22) Filed: Oct. 29, 2010

(51) Int. Cl. G06Q 40/00

(52) U.S. Cl. 705/44

(57) ABSTRACT

Embodiments disclosed herein provide a behavioral based solution to user identity validation, useful in real-time detection of abnormal activity while a user is engaged in an online transaction with a financial institution. A risk modeling system may run two distinct environments: one to train machine learning algorithms to produce classification objects and another to score user activities in real-time using these classification objects. In both environments, activity data collected on a particular user is mapped to various behavioral models to produce atomic elements that can be scored. Classifiers may be dynamically updated in response to new behavioral activities. Example user activities may include login, transactional, and traverse. In some embodiments, depending upon configurable settings with respect to sensitivity and/or specificity, detection of an abnormal activity or activities may not trigger a flag-and-notify unless an attempt is made to move or transfer money.

### TECHNICAL FIELD

This disclosure relates generally to online entity identity validation and transaction authorization. More particularly, embodiments disclosed herein relate to online entity identity validation and transaction authorization for self-service channels provided to end users by financial institutions. Even more particularly, embodiments disclosed herein related to a system, method, and computer program product for adversarial masquerade detection and detection of potentially fraudulent or unauthorized transactions.

### BACKGROUND OF THE RELATED ART

Since the beginning of commerce, one main concern for financial service providers has been how to adequately validate a customer's identity. Traditionally, validation on a customer's identify is done by requiring the customer to provide a proof of identity issued by a trusted source such as a governmental agency. For example, before a customer can open a new account at a bank, he or she may be required to produce some kind of identification paper such as a valid driver's license, current passport, or the like. In this case, physical presence of the banking customer can help an employee of the bank to verify that customer's identify against personal information recorded on the identification paper (e.g., height, weight, eye color, age, etc.).

Without physical presence, this type of identity verification process is not available to financial institutions doing or wanting to do business online. Many financial institutions therefore have adopted a conventional online security solution that has been and is still currently used by many web sites across industries. This conventional online security solution typically involves a user login (username) and password. For example, to log in to a web site that is operated by a financial institution or financial service provider, a user is required to supply appropriate credentials such as a valid username and a correct password. This ensures that only users who possess the appropriate credentials may gain access to the web site and conduct online transactions through the web site accordingly.

While this conventional identity verification method has worked well for many web sites, it may not be sufficient to prevent identity theft and fraudulent online activities using stolen usernames and passwords. Some online banking web sites now utilize a more secure identify verification process that involves security questions. For example, when a user logs into an online banking web site, in addition to providing his or her user identification and password, the user may be presented with one or more security questions. To proceed, the user would need to supply the correct answer(s) to the corresponding security question(s). Additional security measures may be involved. For example, the user may be required to verify an image before he or she is allowed to proceed. After the user completes this secure identify verification process, the user may gain access to the web site to conduct online transactions. If the user identification is associated with multiple accounts, the user may be able to switch between these accounts without having to go through the identify verification process again.

Advances in information technology continue to bring challenges in adequately validating user identity, preventing fraudulent activities, and reducing risk to financial service providers. Consequently, there is always room for improvement.

### SUMMARY OF THE DISCLOSURE

Embodiments disclosed herein provide a system, method, and computer program product useful in real-time detection of abnormal activity while a user is engaged in an online transaction with a financial institution. In some embodiments, a risk modeling system may comprise a behavioral analysis engine operating on a computer having access to a production database storing user activity data. The risk modeling system may operate two distinct environments: a real-time scoring environment and a supervised, inductive machine learning environment.

In some embodiments, the behavioral analysis engine may be configure to partition user activity data into a test partition and a train partition and map data from the train partition to a plurality of modeled action spaces to produce a plurality of atomic elements. Each atomic element may represent or otherwise associated with a particular user action. Examples of such a user action may include login, transactional, and traverse. Within this disclosure, a traverse activity refers to traversing an online financial application through an approval path for moving or transferring money. Examples of modeled action spaces may correspondingly include a Login Modeled Action Space, a Transactional Modeled Action Space, a Traverse Modeled Action Space, etc.

In some embodiments, behavioral patterns may be extracted from the plurality of atomic elements and codified as classification objects. The behavioral analysis engine may be configured to test the classification objects utilizing data from the test partition. Testing the classification objects may comprise mapping data from the test partition to the plurality of modeled action spaces and applying a classification object associated with the particular user action against an atomic element representing the particular user action. This process may produce an array of distinct classification objects associated with the particular user action. The array of classification objects may be stored in a risk modeling database for use in the real-time scoring environment.

In some embodiments, the behavioral analysis engine may be further configured to collect real-time user activity data during an online transaction, produce a real-time atomic element representing the particular user action taken by an entity during the online transaction, select an optimal classification object from the array of distinct classification objects stored in the database, and apply the selected classification object to the real-time atomic element representing the particular user action. Based at least in part on a value produced by the classification object, the behavioral analysis engine may determine whether to pass or fail the particular user action taken by the entity during the online transaction.

In some embodiments, the decision as to whether to pass or fail the particular user action taken by the entity during the online transaction may additionally be based in part on a configuration setting. This configuration setting may pertain to a classification object's performance metric involving sensitivity, specificity, or both. For example, a user or a client may set a high sensitivity in which an abnormal activity may not trigger a flag-and-notify unless that activity involves moving or transferring money. In this case, a classification object that excels at the high sensitivity with respect to that particular type of activity may be applied against the activity and produces Boolean value to indicate whether that activity is a pass or fail. A low sensitivity may be set if the user or client prefers to be notified whenever deviation from normal behavior is detected. If it is determined that the activity should fail, the behavioral analysis engine may operate to flag the particular user action in real-time and notify, in real-time, a legitimate account holder, a financial institution servicing the account, or both. In some embodiments, the behavioral analysis engine may further operate to stop or otherwise prevent the money from being moved or transferred from the account.

In some embodiments, the decision as to whether to pass or fail the particular user action taken by the entity during the online transaction may additionally be based in part on a result produced by a policy engine. This policy engine may run on the real-time user activity data collected during the online transaction.

Embodiments disclosed herein can provide many advantages. For example, the traditional username and password are increasingly at risk of being compromised through a host of constantly adapting techniques. Embodiments disclosed herein can augment the traditional model with an additional layer of authentication which is at once largely transparent to the end user and significantly more difficult to compromise by adversarial entities. Because the end user's behavior and actions are modeled explicitly, there is no reliance on a “shared secret” or masqueradable element as in many secondary authentication schemes.

Via machine learning, the process of building the evaluation models can be automated and then executed in real-time, as well. By contrast, in a conventional approach, behavior is examined after the creation of a new payment. The real-time nature of embodiments disclosed herein can eliminate the “visibility gap” in time between payment creation or attacker login and the fulfillment of the payment, leading to a reduction in risk of loss and the capability to challenge the end user for more authenticating information, again in real-time.

Another issue relates to observing and adapting to emerging fraud patterns. Traditional techniques involve the collection of known instances of fraudulent activity and the subsequent development of rules designed to identify similar actions. Embodiments disclosed herein can avoid the difficulties inherent in addressing a moving target of emerging fraud patterns by approaching this issue in a manner wholly distinct from conventional approaches. For example, rather than attempting to define and identify all fraudulent activity, some embodiments disclosed herein endeavor to identify anomalous activity with respect to individual end users' behavioral tendencies. From this perspective, a majority of fraudulent activity fits nicely as a subset into the collection of anomalous activity.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a diagrammatic representation of simplified network architecture in which some embodiments disclosed herein may be implemented;

FIG. 2 depicts a diagrammatical representation of an example transaction between a user and a financial institution via a financial application connected to one embodiment of a risk modeling system;

FIG. 3 depicts a diagrammatical representation of one embodiment of a top level system architecture including a behavioral analysis engine and a behavioral classifier database coupled thereto;

FIG. 4 depicts an example flow illustrating one embodiment of a process executing in a Supervised, Inductive Machine Learning environment;

FIG. 5 depicts an example flow illustrating one embodiment of a process executing in a Real-Time Scoring Environment;

FIG. 6 depicts a diagrammatical representation of one embodiment of a Supervised, Inductive Machine Learning environment; and

FIG. 7 depicts a diagrammatical representation of one embodiment of a Real-Time Scoring Environment

### DETAILED DESCRIPTION

The disclosure and various features and advantageous details thereof are explained more fully with reference to the exemplary, and therefore non-limiting, embodiments illustrated in the accompanying drawings and detailed in the following description. Descriptions of known programming techniques, computer software, hardware, operating platforms and protocols may be omitted so as not to unnecessarily obscure the disclosure in detail. It should be understood, however, that the detailed description and the specific examples, while indicating the preferred embodiments, are given by way of illustration only and not by way of limitation. Various substitutions, modifications, additions and/or rearrangements within the spirit and/or scope of the underlying inventive concept will become apparent to those skilled in the art from this disclosure.

Software implementing embodiments disclosed herein may be implemented in suitable computer-executable instructions that may reside on a non-transitory computer readable storage medium. Within this disclosure, the term “computer readable storage medium” encompasses all types of data storage medium that can be read by a processor. Examples of computer readable storage media can include random access memories, read-only memories, hard drives, data cartridges, magnetic tapes, floppy diskettes, flash memory drives, optical data storage devices, compact-disc read-only memories, and other appropriate computer memories and data storage devices.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like.

Attention is now directed to embodiments of a system, method, and computer program product for financial transaction risk and fraud analytics and management, including real-time, online, and mobile applications thereof. In recent years, advances in information technology provide end users with convenient and user friendly software tools to conduct transactions, including financial transactions, via an anonymous network such as the Internet or a mobile device carrier network. End-user-facing software applications which hold sensitive data and provide payment and transfer functionality require a strong, reliable mechanism to authenticate the identity of remote end users as well as to impose authorization hurdles in the approval path for payments and transfers initiated in self-service channels, such as online and mobile banking.

A typical solution to validate a user identity is to require the user to submit a valid username and password pair. This ensures that only those in possession of appropriate credentials may gain access, for instance, to a web site or use a software application. If, by some means, an entity other than a legitimate entity acquires these credentials, then, from the perspective of the software application, the illegitimate entity may fully assume the identity of the legitimate entity attached to the username and password, thereby gaining access to the full set of privileges, functionality, and data afforded to the legitimate entity.

Several existing methods of transactional analysis focus solely on the transaction amount as a behavioral indicator. These methods suffer from an inherent insufficiency in that, in practice, transaction amount values are highly variable and, taken alone, provide an unreliable indicator of legitimate usage.

Other techniques focus on collecting and identifying known historical fraudulent activity patterns. From these data sets, static collections of rules are amassed and deployed. New activity is evaluated against these rules. Utilizing these rules, an entity's potentially fraudulent behavior may be detected based upon its similarity to past fraud attempts. These techniques are, by definition, reactive and lack entirely the capability of addressing novel and emerging fraudulent activity.

A number of systems have been implemented that utilize additional shared information (e.g., personal questions, stored cryptographic tokens, dynamically generated cryptographic tokens, etc.) to attempt to strengthen the authentication mechanisms. As attackers have developed many methods to subvert the presently available methods, many of these are obtrusive to the end user and may not add any efficacy to user identity validation.

Embodiments disclosed herein provide an additional layer of authentication to user identity validation. This behavioral based authentication is largely transparent to end users and, as compared to conventional secondary authentication schemes, significantly more difficult to compromise by attackers, adversarial parties, illegitimate entities, or the like.

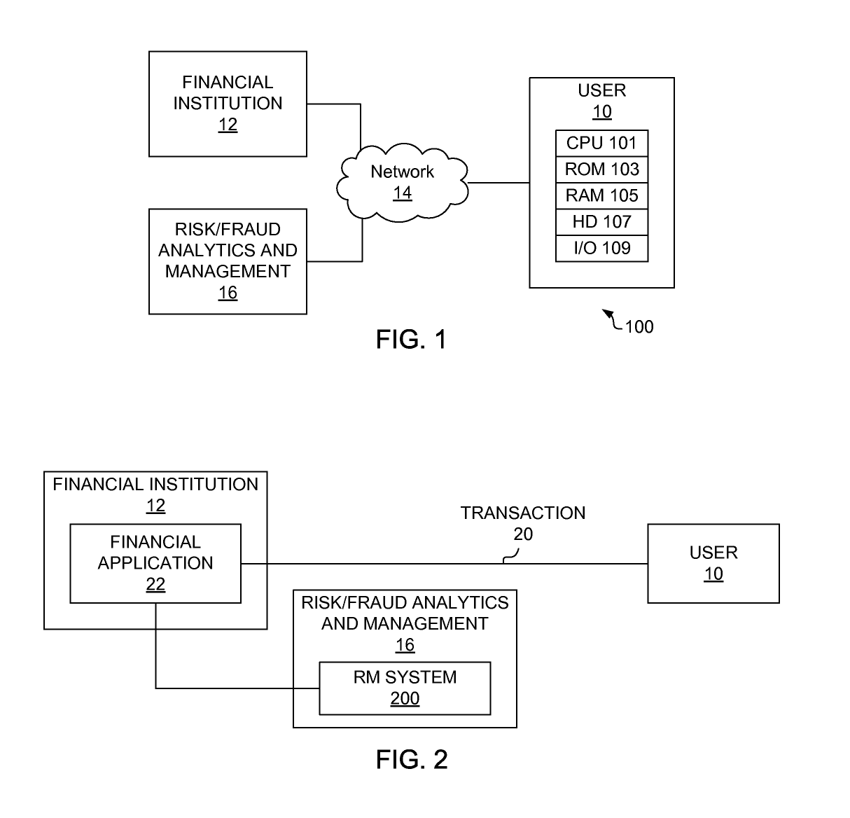

It may be helpful to first describe an example network architecture in which embodiments disclosed herein may be implemented. FIG. 1 depicts simplified network architecture 100. As one skilled in the art can appreciate, the exemplary architecture shown and described herein with respect to FIG. 1 is meant to be illustrative and non-limiting.

In FIG. 1, network architecture 100 may comprise network 14. Network 14 can be characterized as an anonymous network. Examples of an anonymous network may include Internet, a mobile device carrier network, and so on. Network 14 may be bi-directionally coupled to a variety of networked systems, devices, repositories, etc.

In the simplified configuration shown in FIG. 1, network 14 is bi-directionally coupled to a plurality of computing environments, including user computing environment 10, financial institution (FI) computing environment 12, and risk/fraud analytics and management (RM) computing environment 16. User computing environment 10 may comprise at least a client machine. Virtually any piece of hardware or electronic device capable of running software and communicating with a server machine can be considered a client machine. An example client machine may include a central processing unit (CPU) 101, read-only memory (ROM) 103, random access memory (RAM) 105, hard drive (HD) or non-volatile memory 107, and input/output (I/O) device(s) 109. An I/O device may be a keyboard, monitor, printer, electronic pointing device (e.g., mouse, trackball, etc.), or the like. The hardware configuration of this machine can be representative to other devices and computers alike coupled to network 14 (e.g., desktop computers, laptop computers, personal digital assistants, handheld computers, cellular phones, and any electronic devices capable of storing and processing information and network communication). User computing environment 10 may be associated with one or more users. As used herein, user 10 represents a user and any software and hardware necessary for the user to communicate with another entity via network 14.

Similarly, FI 12 represents a financial institution and any software and hardware necessary for the financial institution to conduct business via network 14. For example, FI 12 may include financial application 22. Financial application 22 may be a web based application hosted on a server machine in FI 12. Those skilled in the art will appreciate that financial application 22 may be adapted to run on a variety of network devices. For example, a version of financial application 22 may run on a smart phone.

In some embodiments, RM computing environment 16 may comprise a risk/fraud analytics and management system disclosed herein. Embodiments disclosed herein may be implemented in suitable software including computer-executable instructions. As one skilled in the art can appreciate, a computer program product implementing an embodiment disclosed herein may comprise one or more non-transitory computer readable storage media storing computer instructions translatable by one or more processors in RM computing environment 16. Examples of computer readable media may include, but are not limited to, volatile and non-volatile computer memories and storage devices such as ROM, RAM, HD, direct access storage device arrays, magnetic tapes, floppy diskettes, optical storage devices, etc. In an illustrative embodiment, some or all of the software components may reside on a single server computer or on any combination of separate server computers.

FIG. 2 depicts a diagrammatical representation of example transaction 20 between user 10 and FI 12 via financial application 22. In some embodiments, RM computing environment 16 may comprise risk/fraud analytics and management (or simply risk modeling or RM) system 200. System 200 may comprise software components residing on a single server computer or on any combination of separate server computers. In some embodiments, system 200 may model behavioral aspects of user 10 through a real-time behavioral analysis and classification process while user 10 is conducting transaction 20 with FI 12 via financial application 22. In some embodiments, system 200 models each end user's behavior and actions explicitly.

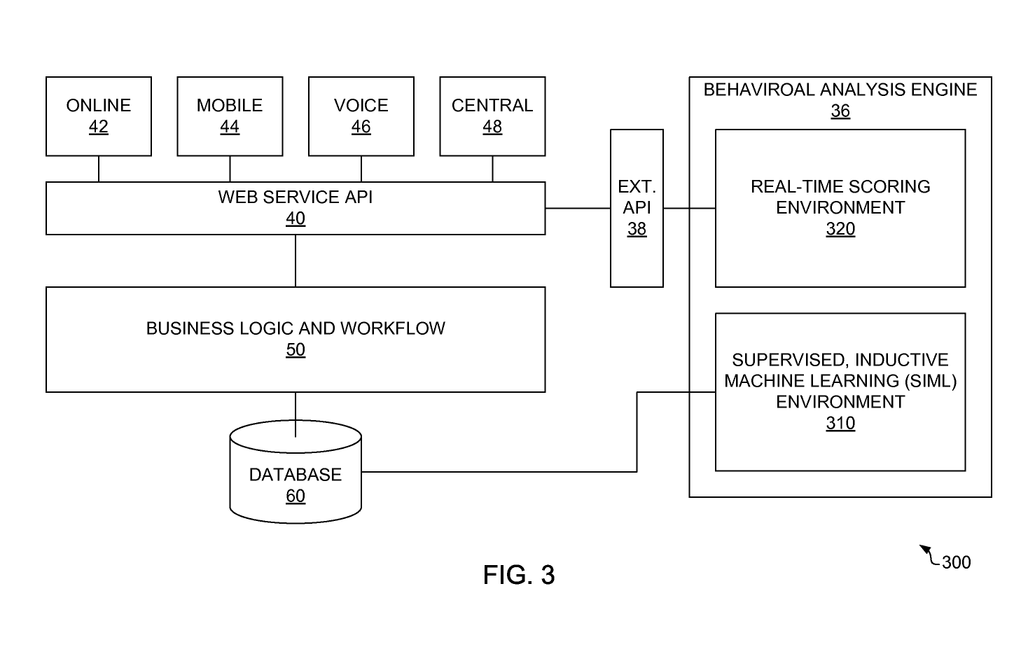

FIG. 3 depicts a diagrammatical representation of top level system architecture 300. In some embodiments, behavioral analysis engine 36 may be responsible for running multiple environments, including Real-Time Scoring Environment 320 and Supervised, Inductive Machine Learning (SIML) Environment 310. The former may be connected to web service API 40 via external API 38 in a manner known to those skilled in the art. The latter may be communicatively coupled and have access to database 60. Database 60 may contain data for use by business logic and workflow layer 50. Business logic and workflow layer 50 may interface with various end-user-facing software applications via web service API 40. Examples of end-user-facing software applications may include online banking application 42, mobile banking application 44, voice banking application 46, and central banking application 48.

In some embodiments, system 200 runs at least two modeling processes in two distinct environments: Real-Time Scoring Environment 320 and Supervised, Inductive Machine Learning (SIML) Environment 310. These modeling approaches will be first described below.

### Login Modeling

Consider an entity, E, which regularly gains remote entry to a software application via the traditional username/password paradigm described above. Further consider the submission of a username and password as a login event. Each login event may be associated with a temporal element and a spatial element. These temporal and spatial elements represent the date/time of the event and the physical location of the machine on which the event is executed, respectively. Over time, and across a sufficient volume of login events, characteristic patterns emerge from legitimate usage. These behavioral patterns can be described in terms of the temporal and spatial elements associated with each login event. As these patterns are often sufficiently distinctive to distinguish one entity from another, embodiments disclosed herein can harness an entity's behavioral tendencies as an additional identity authentication mechanism. This behavioral based authentication mechanism can be used in conjunction with the traditional username and password paradigm. In this way, an entity attempting a login event must supply a valid username/password, and do so in a manner that is consistent with the behavioral patterns extant in the activity history corresponding to the submitted username/password.

### Transaction Modeling

As an end user traverses the approval path for a payment or transfer, a rich set of behavioral aspects may be collected and attached or otherwise associated, atomically, to that individual transaction. As in the Login model, over time, and across a sufficient volume of activity, characteristic patterns emerge from legitimate usage.

Both the Login and Transaction modeling processes rely on supervised machine learning algorithms to produce classification objects (also referred to herein as classifiers) from behavioral histories. Examples of suitable supervised machine learning algorithms may include, but are not limited to, Support Vector Machine, Bayesian Network, Decision Tree, k Nearest Neighbor, etc.

Importantly, the behavioral models that these algorithms produce consider and evaluate all of the various behavioral elements of an end user's activity in concert. Specifically, individual aspects of behavior are not treated as isolated instances, but as components of a larger process. The Login and Transaction models are dynamic and adaptive. As end users' behavioral tendencies fluctuate and drift, the associated classification objects adjust accordingly.

The real-time behavioral analysis and classification process employed by each of the Login and Transaction models relies on the ready availability of classification objects. Thus, in some embodiments, system 200 may implement two processes, Process I and Process II, each distinct in purpose. Process I is executed in Supervised, Inductive Machine Learning Environment 310 and involves the production of classification objects. Process II is executed in Real-Time Scoring Environment 320 and concerns the application of these classification objects in real time.

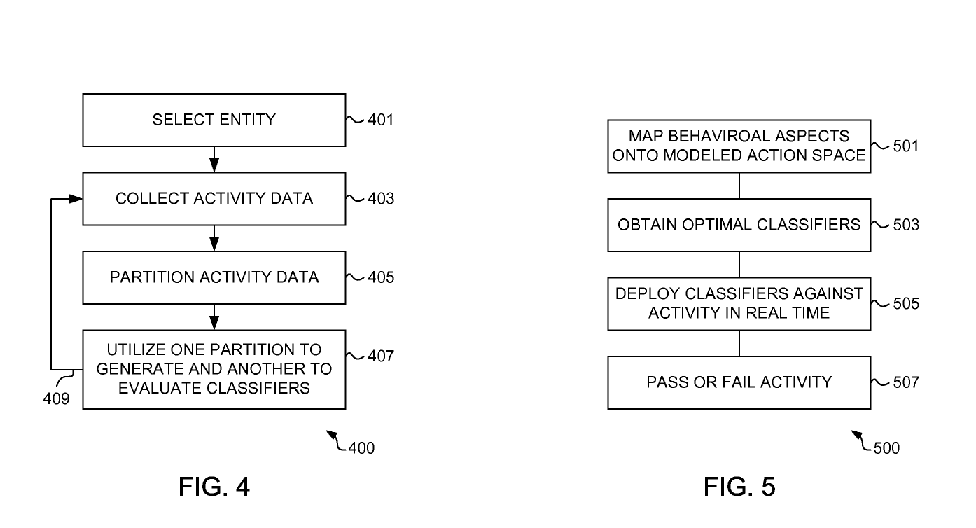

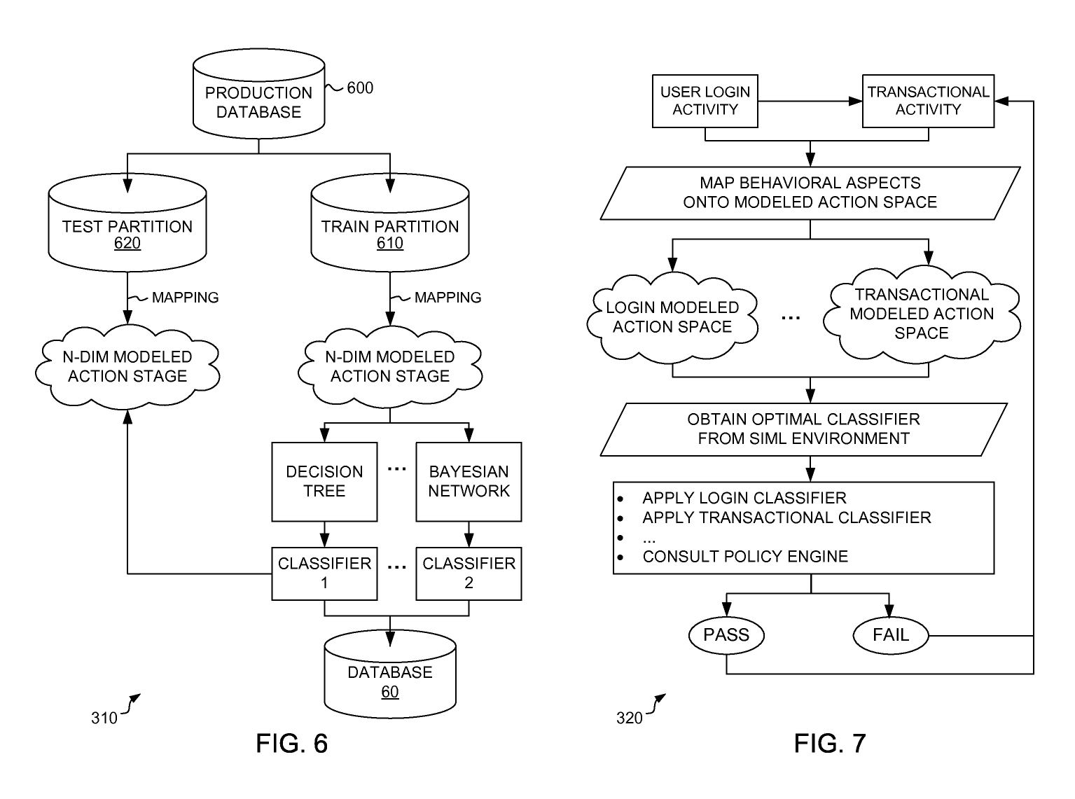

First, consider process I. FIG. 4 depicts example flow 400 illustrating one embodiment of process I which begins with the choice of a single entity, E, representing a software end user (step 401). E's activity is then collected (step 403). Referring to FIG. 6, which depicts a diagrammatical representation of one example embodiment of Supervised, Inductive Machine Learning Environment 310, activity data thus collected by system 200 may be stored in production database 600. An example activity may be E's interaction with financial application 22. Examples of activity data may include network addresses (e.g., IP addresses), date, and time associated with such interaction. When the accumulated volume of activity associated to E is sufficient, the complete activity history is partitioned into two distinct sets (step 405). As an example, sufficiency may be established when the amount of activity data collected meets or exceeds a predetermined threshold.

One of these sets is used to produce classification objects (also referred to as classifiers) and another set is used to evaluate the accuracy of these classifiers (step 407). In the example of FIG. 6, these data sets are referred to as train partition 610 and test partition 620, respectively. Process I may supply elements from train partition 610 as input to various supervised machine learning algorithms to produce classifiers. Process I may utilize elements from test partition 620 to evaluate the classifiers thus produced. This evaluation process may yield an a priori notion of a classification object's ability to distinguish legitimate behavior. In this way, when the Real-Time Scoring Environment 320 requires a classification object for a given end user, the Supervised, Inductive Machine Learning (SIML) Environment 310 may choose the unique optimal one from the collection of classification objects associated to that end user.

From an analytical standpoint, behavioral elements are represented as points in a Modeled Action Space. Non-limiting examples of Modeled Action Space definitions are provided below. Modeled Action Spaces are populated by supervised machine learning examples (SMLEs). Each SMLE represents, atomically, an action (Login or Transactional) taken by an end user. The precise form of each SMLE is determined by a proprietary discretization algorithm which maps the various behavioral aspects surrounding an action to a fixed-length vector representing the SMLE itself. The supervised machine learning algorithms extract behavioral patterns from input SMLE sets and codify these patterns in the form of classification objects. Once the initial activity volume level is achieved, and process I is actuated, flow 400 enters into a cyclical classification object regeneration pattern 409, which captures, going forward, all novel, legitimate activity associated to E, and incorporates this activity into newly generated classification objects to account for the real-world, changing behaviors that individual users exhibit.

Next, consider process II. FIG. 5 depicts example flow 500 illustrating one embodiment of process II. As an end user logs in and traverses the online banking application through the approval path for payments and transfers, various behavioral aspects comprising that user's actions are mapped onto Modeled Action Spaces (step 501). When a transaction is submitted for authorization, the optimal classification objects associated to that end user are gathered (step 503) from Supervised, Inductive Machine Learning Environment 310 and deployed against the collected behavioral elements in real time (step 505). As a result, flow 500 may determine whether to fail or pass the authorization (step 507).

Utilizing machine learning technologies, the process of building the evaluation models (e.g., Process I) can be automated and then executed in real-time as well. This is in contrast to other offerings currently in the marketplace in which behavior is usually examined after the creation of a new payment. The real-time nature of embodiments disclosed herein can eliminate this “visibility gap” in the time between a payment creation or attacker login and the fulfillment of the payment, leading to a reduction in risk of loss and the capability to challenge the end user for more authenticating information, again in real-time.

The problem of observing and adapting to emerging fraud patterns has been mentioned. Additionally, conventional techniques which involve the collection of known instances of fraudulent activity and the subsequent development of rules designed to identify similar actions have been noted. Embodiments disclosed herein can avoid the difficulties inherent in addressing the moving target of emerging fraud patterns by approaching the issue in a manner wholly distinct from that above. Rather than addressing the problem by attempting to define and identify all fraudulent activity, embodiments disclosed herein endeavor to identify, in real time, anomalous activity with respect to individual end users' behavioral tendencies in a manner that is quite transparent to the end users.

As discussed above, behavioral elements or aspects associated with a user transaction may be represented as points in a Modeled Action Space. As illustrated in FIG. 6, there can be a plurality of Modeled Action Spaces, each defining a plurality of behavioral elements or aspects. Together these Modeled Action Spaces form an N-dimensional Modeled Action stage. At this stage, each action (Login or Transactional) taken by an end user may be associated with a set of behavioral elements or aspects from one or more Modeled Action Spaces.

Table 1 below illustrates an example Login Modeled Action Space with a list of defined login behavioral elements. In some embodiments, the datetime decomposition elements (also referred to as temporal and spatial elements) in Table 1 may provide a mechanism by which behavioral patterns may be captured across several time scales (e.g., month, week, day, etc.).

TABLE 1
Login Modeled Action Space Definition

| | |
|---|---|
| Login Week | Each calendar month may be partitioned into a |
| | set of either four or five weeks. Login Week |
| | provides an integer representation of the week |
| | in which the Login event is attempted. |
| Login Day | Provides an integer representation of the |
| | weekday on which the Login event is attempted. |
| Login Hour | A discretized integer representation of the |
| | hour of day during which the Login event is |
| | attempted. |
| Login State | During each Login event, the IP address of the |
| | remote client machine is collected. |
| | Subsequently, the client address is mapped by |
| | an IP geolocation service to the U.S. state in |
| | which the remote physical machine is located. |

Table 2 below illustrates an example Automated Clearing House (ACH) Modeled Action Space with a list of defined ACH transactional behavioral elements. ACH is an electronic network for financial transactions and processes large volumes of credit and debit transactions in batches, including direct deposit payroll, vendor payments, and direct debit transfers such as consumer payments on insurance premiums, mortgage loans, and various types of bills. Businesses are increasingly relying on ACH to collect from customers online.

In some embodiments, an ACH transaction recipient list may be defined as a set of accounts into which a particular transaction moves funds. From this ACH transaction recipient list, several auxiliary lists may be defined. For example, each account from the recipient list may be associated with a unique routing transit number (RTN) such as one derived from a bank's transit number originated by the American Bankers Association (ABA). An ABA number is a nine digit bank code used in the United States and identifies a financial institution on which a negotiable instrument (e.g., a check) was drawn. Traditionally, this bank code facilitates the sorting, bundling, and shipment of paper checks back to the check writer (i.e., payer). Today, the ACH may use this bank code to process direct deposits, bill payments and other automated transfers.

In some embodiments, each ABA number may map uniquely to an ABA district. In this way, a collection of ABA districts derived from the recipient list may define an ACH transaction Federal Reserve district list. The Federal Reserve Banks are collectively the nation's largest ACH operator. In some embodiments, a similar list may be defined for another ACH operator such as the Electronic Payments Network.

In some embodiments, each element of the ACH transaction recipient list may be associated to a real number value which represents the dollar amount being moved to that element (account). This collection of values may define an ACH transaction amount list.

In some embodiments, the datetime decomposition elements in Table 2 may provide a mechanism by which behavioral patterns may be captured across several time scales (e.g., month, week, day, etc.).

TABLE 2
ACH Modeled Action Space Definition

| | |
|---|---|
| Transaction Amount | Real number representation of the total |
| | amount transferred. If the transaction |
| | contains multiple recipients, the |
| | Transaction Amount represents the sum total |
| | of all individual recipient amounts. |
| Create Week | Each calendar month may be partitioned into |
| | a set of either four or five weeks. Create |
| | Week provides an integer representation of |
| | the week in which the ACH transaction was |
| | drafted. |
| Create Day | Provides an integer representation of the |
| | weekday on which the ACH transaction was |
| | drafted. |
| Create Hour | A discretized integer representation of the |
| | hour of day during which the ACH |
| | transaction was drafted. |
| Authorized Week | Constructed similarly to the Create Week |
| | attribute. Provides the integer |
| | representation of the week in which the ACH |
| | transaction is submitted for authorization. |
| Authorized Day | Constructed similarly to the Create Day |
| | attribute. Provides the integer |
| | representation of the weekday on which the |
| | ACH transaction is submitted for |
| | authorization. |
| Authorized Hour | Constructed similarly to the Create Hour |
| | attribute. Provides the discretized |
| | integer representation of the hour of day |
| | during which the ACH transaction is |
| | submitted for authorization. |
| Wait Time | Real number representation of the time |
| | duration, in fractional seconds, from ACH |
| | transaction creation to ACH transaction |
| | authorization submittal. |
| Discretionary Data | Boolean value which is ‘True’ if |
| Verbosity | the ACH transaction contains discretionary |
| | data. If the ACH transaction contains no |
| | discretionary data, this value is ‘False.’ |
| Addenda Verbosity | Boolean value which is ‘True’ if the ACH |
| | transaction contains addenda records. If |
| | the ACH transaction has no addenda records |
| | present, this value is ‘False.’ |
| Recipient Count | Integer representation of the number of |
| | distinct recipients listed for the ACH |
| | transaction (length of the recipient list). |
| District Count | Integer representation of the number of |
| | distinct Federal Reserve districts |
| | contained in the ACH transaction district |
| | list. |
| ABA Count | Integer representation of the number of |
| | distinct ABA routing transit numbers |
| | contained in the ACH transaction recipient |
| | list. |
| District Mode | Provides the most common Federal Reserve |
| | district from the ACH transaction district |
| | list. |
| District Majority Amount | From the list of Federal Reserve |
| | districts, return the district to which the |
| | maximum transactional dollar amount is |
| | bound. |
| Amount Mean | Real number representation of the mean |
| | dollar amount from the ACH transaction |
| | amount list. |
| Amount Minimum | Real number representation of the minimum |
| | dollar amount from the ACH transaction |
| | amount list. |
| Amount Maximum | Real number representation of the maximum |
| | dollar amount from the ACH transaction |
| | amount list. |
| Amount Median | Real number representation of the median |
| | dollar amount from the ACH transaction |
| | amount list. |
| Amount Variance | Real number representing the variance of |
| | the probability distribution consisting of |
| | all values from the ACH transaction amount |
| | list. |
| Amount Skewness | Real number representing the skewness of |
| | the probability distribution consisting of |
| | all values from the ACH transaction amount |
| | list. |
| Amount Kurtosis | Real number representing the kurtosis of |
| | the probability distribution consisting of |
| | all values from the ACH transaction amount |
| | list. |

In some embodiments, the datetime decomposition elements in Table 3 may provide a mechanism by which behavioral patterns may be captured across several time scales (e.g., month, week, day, etc.).

TABLE 3
Domestic Wire Transfer Modeled Action Space Definition

| | |
|---|---|
| Transaction Amount | Real number representation of the total |
| | amount transferred. If the transaction |
| | contains multiple recipients, the |
| | Transaction Amount represents the sum total |
| | of all individual recipient amounts. |
| Create Week | Each calendar month may be partitioned into |
| | a set of either four or five weeks. Create |
| | Week provides an integer representation of |
| | the week in which the Domestic Wire |
| | transaction was drafted. |
| Create Day | Provides an integer representation of the |
| | weekday on which the Domestic Wire |
| | transaction was drafted. |
| Create Hour | A discretized integer representation of the |
| | hour of day during which the Domestic Wire |
| | transaction was drafted. |
| Authorized Week | Constructed similarly to the Create Week |
| | attribute. Provides the integer |
| | representation of the week in which the |
| | Domestic Wire transaction is submitted for |
| | authorization. |
| Authorized Day | Constructed similarly to the Create Day |
| | attribute. Provides the integer |
| | representation of the weekday on which the |
| | Domestic Wire transaction is submitted for |
| | authorization. |
| Authorized Hour | Constructed similarly to the Create Hour |
| | attribute. Provides the discretized integer |
| | representation of the hour of day during |
| | which the Domestic Wire transaction is |
| | submitted for authorization. |
| Wait Time | Real number representation of the time |
| | duration, in fractional seconds, from |
| | Domestic Wire transaction creation to |
| | Domestic Wire transaction authorization |
| | submittal. |
| To Account Type | Represents the type of receiving account |
| | (Checking or Savings). |
| Description Verbosity | Boolean value which is ‘True’ if the |
| | Domestic Wire transaction contains a |
| | nonempty description. |
| Beneficiary State | String representation of the U.S. state in |
| | which the beneficiary financial institution |
| | is located. |
| Beneficiary Federal | String representation |
| Reserve District | of the Federal Reserve district to which |
| | the beneficiary financial institution |
| | belongs. |

In some embodiments, the datetime decomposition elements in Table 3 may provide a mechanism by which behavioral patterns may be captured across several time scales (e.g., month, week, day, etc.).

As discussed above, as an end user logs in and traverses an online banking application through the approval path for payments and transfers, various behavioral aspects comprising that user's actions can be mapped onto Modeled Action Spaces. In some embodiments, a traversal may be defined as the ordered set of actions taken by an end user between a Login event and a Transaction Authorization event. Each of the several hundred actions available to a software end user may be associated to one of a plurality of distinct Audit Categories. In some embodiments, the length of a traversal may be defined as the total number of actions taken by an end user over the course of a traversal.

In some embodiments, for a traversal T of length N, and some category C, a Category Frequency of C may be defined as the total number of actions from T which fall into category C. Finally, a Category Relative Frequency of C may be defined as the category frequency of C divided by N. As an example, attributes listed in Table 4 below make use of the category relative frequency (CRF).

TABLE 4
Traversal Modeled Action Space Definition

| | |
|---|---|
| Administration Group CRF | Relative frequency of audit category: |
| | Administration Group |
| Administration User CRF | Relative frequency of audit category: |
| | Administration User |
| Audit CRF | Relative frequency of audit category: |
| | Audit |
| Customer CRF | Relative frequency of audit category: |
| | Customer |
| Group CRF | Relative frequency of audit category: |
| | Group |
| Host Account CRF | Relative frequency of audit category: |
| | Host Account |
| Reports CRF | Relative frequency of audit category: |
| | Reports |
| Secure Message CRF | Relative frequency of audit category: |
| | Secure Message |
| System Administration CRF | Relative frequency of audit |
| | category: System Administration |
| Transaction Code CRF | Relative frequency of audit category: |
| | Transaction Code |
| Transaction Processing CRF | Relative frequency of audit |
| | category: Transaction Processing |
| Transactions CRF | Relative frequency of audit category: |
| | Transactions |
| Alerts CRF | Relative frequency of audit category: |
| | Alerts |
| Marketing Message CRF | Relative frequency of audit category: |
| | Marketing Message |
| Authentication CRF | Relative frequency of audit category: |
| | Authentication |
| Bill Payment CRF | Relative frequency of audit category: |
| | Bill Payment |
| Template Recipient CRF | Relative frequency of audit category: |
| | Template Recipient |
| Api CRF | Relative frequency of audit category: |
| | API |
| Dashboard CRF | Relative frequency of audit category: |
| | Dashboard |
| Funds Transfer Count | Number of Funds Transfer transactions |
| | executed |
| Bond Order Count | Number of Bond Order transactions |
| | executed |
| Change Of Address Count | Number of Change Of Address |
| | transactions executed |
| Stop Payment Count | Number of Stop Payment transactions |
| | executed |
| Currency Order Count | Number of Currency Order transactions |
| | executed |
| Domestic Wire Count | Number of Domestic Wire transactions |
| | executed |
| International Wire Count | Number of International Wire |
| | transactions executed |
| Bill Payment Count | Number of Bill Payment transactions |
| | executed |
| Ach Batch Count | Number of Ach Batch transactions |
| | executed |
| Check Reorder Count | Number of Check Reorder transactions |
| | executed |
| Rck Count | Number of Rck transactions executed |
| Eftps Count | Number of Eftps transactions executed |
| Ach Receipt Count | Number of Ach Receipt transactions |
| | executed |
| Payroll Count | Number of Payroll transactions |
| | executed |
| Ach Payment Count | Number of Ach Payment transactions |
| | executed |
| Ach Collection Count | Number of Ach Collection transactions |
| | executed |
| Funds Verification Count | Number of Funds Verification |
| | transactions executed |
| External Transfer Count | Number of External Transfer |
| | transactions executed |
| Send Check Count | Number of Send Check transactions |
| | executed |
| Ach Pass Thru Count | Number of Ach Pass Thru transactions |
| | executed |
| Event Total | Number of actions taken by user in |
| | current login session up to now |
| GT Type | Type of generated transaction for |
| | which authorization is being |
| | attempted |
| Session Duration | Length, in units of time, of |
| | traversal |
| Login Week, Login Day, | Temporal data around Login |
| Login Hour | event which initiated the current |
| | traversal |

Referring back to FIG. 6, as discussed above, raw historical transaction data from production database 600 may be divided into train partition 610 and test partition 620. Such historical transaction data may be collected by a financial institution and may include dates, times, and network addresses (e.g., Internet Protocol (IP) addresses) of client machines that log on to server machine(s) operated by the financial institution through a front end financial software application (e.g., e-banking, mobile banking, etc.).

Raw data from train partition 610 may be mapped onto the N-dimensional Modeled Action stage having multiple Modeled Action Spaces. As exemplified in Tables 1-4 above, each Modeled Action Space may define a set of behavioral elements or aspects. Outputs from the various Modeled Action Spaces can be analyzed and mapped to fixed-length vectors, each associated with a particular action. An example of a vector may be a domestic wire transfer with each one of the attributes in Table 3 populated. Notice that there is no overlap between Modeled Action Spaces; they use entirely distinct variables. It is important that these different behavioral models are orthogonal so that they do not measure redundant variables.

More specifically, a vector may represent a supervised machine learning example (SMLE) which, in turn, may represent the particular action. The SMLEs are then fed to a plurality of software modules implementing supervised machine learning (SML) algorithms to extract behavioral patterns. Suitable example SML algorithms may include, but are not limited to, decision trees, Bayesian network, nearest-neighbor models, support vector machines, etc. These SML algorithms are examples of artificial intelligence algorithms. Other machine learning algorithms may also be used. Patterns extracted from these SMLEs may then be codified into classification objects (e.g., Classifier 1, Classifier 2, etc. in FIG. 6). Through this process, each user is associated with an array of distinct classification objects representing a range of behaviors.

These exists a spectrum of specificity with which these classifiers can evaluate behavior. To distinguish one classifier from another with respect to their ability to accurately classify an action taken by an end user, these classification objects are evaluated before they are deployed against real-time data. To this end, accuracy is decomposed down into two distinct elements called specificity and sensitivity. Highly sensitive models excel at correctly classifying legitimate activity. Highly specific models excel at correctly identifying fraudulent activity. Together they form a metric that can be used to determine the applicability of one classification object versus another. As those skilled in the art will appreciate, the makeup of this metric may change from implementation to implementation. For example, a metric used in the field of online banking may maximize sensitivity; whereas a metric used in the field of medical diagnostics may maximize specificity. With high sensitivity, online banking customers will not be unnecessarily challenged and overly inconvenienced every time they log in. As a result, each user is associated with an array of distinct classifiers, distinguished with respect to sensitivity and specificity.

Note data from train partition 610 may be continuous. The multiple Modeled Action Spaces may provide particular discretizations of this continuous data so they can be optimally and advantageously consumable by the machine learning algorithms to provide meaningful and rich context in analyzing behavioral patterns. As an example, take the login model which has a temporal element and a spatial element. The temporal element is composed of week/day/hour and the spatial element is discretized down to a generally defined area such as a state, and not a specific location. Such a selective discretization can be of vital importance to some types of data. For example, simply taking the date of the month would have almost no descriptive value. However, it can be observed that people tend to log in to online banking on or around payday and payment dates. Most of those are not necessarily predicated on calendar days as much as they are predicated as day of the week. Similarly, commercial entities have their own kind of rhythm in conducting business transactions.

Some temporal measures of distance such as Login Week (integer week of the month), Login Day (day of the week) and Login Hour can be very specific, because the hour of the day repeats every day, and the day of the week repeats every week. However, they offer a way to discretize the input data in a manner that the underlying algorithms can actually find the meaning in it. Again, the models are trained on a per individual user basis. For a particular user (user 1), the day of the week may have some specificity. For another user (user 2), the day of the week may not have a lot of specificity (e.g., a commercial user that logs in every day). Thus, the computed model for user 2 may not pivot on the day of the week as much as for user 1.

Also note that the word “supervised” in the supervised, inductive machine-learning environment is meant to specify that, in the training stage, an algorithm may receive all the attributes plus one more that designates whether or not a particular action emanated from a particular user. For example, in training a domestic wire transfer model, a trainer may provide two types of domestic wire transfers to a machine learning algorithm—positive examples with legitimate instances of activity for a particular user and negative examples with instances of activity that the trainer knows did not come from that particular user. Both positive and negative examples are input to the machine learning algorithm, which in turn outputs a classification object for that particular user.

As these machine learning algorithms are distinct from one another, they produce distinct classification objects for the same user. Naturally, the same algorithm would produce different classification objects for different users as everything hinges upon individual activity. Certain users behave entirely different than others, and for that reason that user's activity might limit itself to a decision tree to more efficiently classify. For other users, the Bayesian network algorithm might work better. Thus, in general, the algorithms work complementarily.

Every end user gets a set of classifiers, some of which can be very good at identifying abnormal behavior and some of which can be very good at identifying a good transaction. The intent here is not to identify fraudulent activity; it's to identify activity that is anomalous with respect to a particular user. This is unlike other techniques that have existed and that are in existence currently which focus on identifying fraud. For example, a credit card fraud model may build out classifiers to try to find the best classifier for identifying fraud across users. Although historical transaction data may be utilized in such a fraud model, user-centric transactional activity—not to mention individual user login activity—is generally not relied upon to build these classifiers.

Transactional activity can be very atomic: a transaction is a transaction. In embodiments disclosed herein, elements around a transaction are readily collected. These collected elements can help the underlying risk modeling system to distinguish several distinct types of behavior such as user log-on and transactional activity (e.g., a domestic wire transfer). More specifically, the wealth of data collected (e.g., in between the time that the user logged on, since the user's gone through the first application to the point where they made the transaction, where they execute that transaction, and so on.) can be used to train various machine learning algorithms and produce classification objects on a transaction-by-transaction and user-by-user basis.

Depending upon the input ratio on positive and negative examples, each distinct machine learning algorithm may also produce more than one classification objects. For example, in modeling wire transfers, a decision tree algorithm may be given a collection of wire transfers in which the number of positive examples precisely holds to the number of negative examples, on the one hand, and generates a first classification object. The same decision tree algorithm may also be given a skewed distribution, say, a collection of examples that consist of 80 percent of positive activity and 20 percent of negative activity, and generates a second classification object that is entirely distinct from the first classification object.

Both classification objects may act on the next set of data coming in for a domestic wire transfer for that particular user and potentially produce different Boolean scores on the exact same transaction. To understand how they behave, what they excel at, whether or not they are overly specific or sensitive or anywhere in between, and to gauge how well they may perform in the real world, these classification objects are tested before they are deployed and stored in database 60. If all of the raw data is used to train the machine learning algorithms, classification objects produced by these machine learning algorithms would be tested on the same data on which they were built. To test these classifiers in an adversarial manner, raw data from production database 600 is divided into train partition 610 and test partition 620.

More specifically, raw data from test partition 620 is also fed into the N-dimensional Modeled Action stage. Mapping that goes from the raw data to the N-dimensional Modeled Action stage may occur between test partition 620 and the cloud representing the N-dimensional Modeled Action stage in FIG. 6. Outputs from the various Modeled Action Spaces that are associated with a particular action can be analyzed and mapped to a fixed-length vector, representing a behavioral element or SMLE. A SMLE may represent an atomic element that can be scored to determine whether an associated action is within normal behavior of that user for the particular login or transactional activity. Classification objects produced using data from train partition 610 are used to score SMLEs.

The training process described above may be referred to as a classification process. During the classification process, a large set of classifiers may be produced. Testing these classifiers on a different data set from test partition 620 may operate to eliminate those that do not perform well (e.g., with respect to sensitivity and/or specificity for a particular login or transactional action as configured by a user or a client). As an example, test partition 620 may contain behavioral elements surrounding transactional activities that involve moving funds. As another example, test partition 620 may contain behavioral elements surrounding transactional activities for a particular period of time. A specific example might be to train the behavioral models using data from the first 20 minutes of transaction 20 and test the classification objects produced thereby using data from the last 10 minutes of transaction 20. Classifiers that perform well are then stored in risk modeling database 60 along with their performance metrics for use by Real-Time Scoring Environment 320.

Embodiments disclosed herein may be implemented in various ways. For example, in some embodiments, the manner in which a user traverses an online financial application between login and wire transfer activities can be just as distinguishing as the user's temporal pattern. Some embodiments may be implemented to be login-centric where an illegitimate user may be stopped from proceeding further if that user's login behavior is indicated as being abnormal via a classifier that was built using the legitimate user's login behavior. Some embodiments may be implemented to be transactional-centric where if a user is not moving or making an attempt to move or transfer money, abnormality detected in how a user is logged on and how that user traverses the application may not matter. In such an implementation, no notification may be sent to the account holder (the user may or may not be the legitimate account holder) and/or the financial institution unless an attempt by the user to move or transfer money is made. In some embodiments, this level of sensitivity versus specificity may be configurable by an end user or a client of risk modeling system 200 (e.g., a financial institution such as a bank or a branch thereof). On one hand, it could be bank-by-bank configurable, but banks could use different levels of configuration for different customers. For example, high-net-worth customers may get a different sensitivity configuration setting than low-net-worth customers. Moreover, different branches of the same bank could operate differently under different models. On the other hand, this could be user-by-user configurable, but different users may set different levels of sensitivity depending upon their individual tolerance to inconvenience versus risk with respect to the amount of money they could lose.

As an example, a range of sensitivity settings may be provided to an entity (e.g., a user or a client). This range may go from a relatively good amount of deviation from normal activity to a relatively small amount of deviation from normal activity before a notification is triggered. For example, at one end of the range, an entity may be very risk adverse and does not want any unusual activity at all going through, the entity may want to be notified (e.g., by a phone call, an email, an instant message, a push notification, or the like) if an observed activity deviates at all from what a normal activity might look like on an everyday basis. At the other end of the range, an entity may not want to be notified unless an observed activity substantially deviates or is completely different from what a normal activity might look like on an everyday basis.

In some cases, an end user may attempt a transaction that is out of his or her ordinary behavior, causing a false positive scenario. Although legitimate with respect to login and other actions in the transaction, the end user may be notified immediately that the transaction is potentially problematic. The end user may be asked for more proof of their identity.

In some embodiments, sensitivity versus specificity configuration may be done by exposing a choice to an end user, to a financial institution, or the like, and soliciting a response to the choice. This may be implemented in the form of a wizard or questionnaire: “Would you like your classifiers to be more selective or less selective?” or “Do you mind being interrupted on a more frequent basis?” In running various behavior models against a user's activity (action), the underlying system may then operate to consult a performance metrics and decide, based on the configuration setting, which classifier to deploy against that user's activity. In some embodiments, a performance metric may comprise several real-number decimal values, including one representing the sensitivity and another one representing the specificity. As discussed above, in some embodiments, all classification objects matched to individual users are stored in risk modeling database 60, along with their performance metrics. Additional more esoteric ways of measuring the efficacy of a classifier may also be possible.

FIG. 7 depicts a diagrammatical representation of Real-Time Scoring Environment 320. In this case, activity data is collected and, depending upon the type of activity, fed into a corresponding Modeled Action Space in real time. For example, user login activity data may be collected and put into a Login Modeled Action Space. This Login Modeled Action Space is the same as the one described above with reference to the SIML Environment 310. As another example, transactional activity data may be collected and put into a Transactional Modeled Action Space. Again, this Transactional Modeled Action Space is the same as the one described above with reference to the SIML Environment 310.

Attributes produced by these Modeled Action Spaces are score-able atomic elements which can then be made available to classification objects. At this point, Real-Time Scoring Environment 320 may operate to access risk modeling database 60, get the optimal classifier per whatever action it is modeling, and bring it back into the real-time environment. This optimal classifier may then be applied to score the new activity. For example, a login classifier may be applied to score a login as legitimate or illegitimate. Similarly, a transactional classifier may be applied to score a transactional activity or a traversal classifier may be applied to score a traversal activity.

Additional constraints may be applied. For example, Real-Time Scoring Environment 320 may consult a policy engine that can be run on the same base data. This policy engine may contain a plurality of rules. As an example, a rule may state that a transaction over $100,000.00 must be flagged and the user and/or bank notified. Thus, in this embodiment, a user activity may be a pass if it involves less than $100,000.00 and passes a login classifier, a transactional classifier, a traversal classifier, or other behavioral classifier.

Note that a classifier is a self-contained classification object. When instantiated, each classifier may query individual attributes. More specifically, a classifier may use all attributes defined in a particular Modeled Action Space, or it may select a set of attributes to use. This attribute selection process occurs entirely within the classifier itself and is not visible to humans. Although it is not possible to see which attributes are actually being used in a classifier, it is possible to guess by going back and looking at that individual user's transactional history.

Internally, when building a classifier a machine learning algorithm may select, based upon a statistical analysis of all the data that it received, a collection of attributes for the classifier to query. Thus, during the classification process, an extremely large number of classifiers may be built and the algorithm may select a classifier based on the performance of that classifier against a particular action.

Different machine learning algorithms may behave differently and produce different types of output. Decision trees, for instance, really are two-element discrete. Some algorithms may return a real number between zero and one. An artisan will appreciate that a normalization process may be applied to derive discrete values (e.g., true/false; pass/fail; yes/no; zero/one, etc.) so that these classification objects may return Boolean values to pass or fail a particular action.

Referring to FIGS. 2 and 7, in some embodiments, during transaction 20, actions taken by user 10 may cause system 200 to generate a plurality of SMLEs in real-time, each SMLE representing a distinct user action. For a given end user taking a particular action, SIML Environment 310 may provide an array of distinct classifiers for Real-Time Scoring Environment 320 to choose from that may vary in their performances with respect to sensitivity and specificity.

In some embodiments, a single classifier may be selected from the array of distinct classifiers and run against a specific user activity. The selected classifier may represent the best (optimal) classifier for that data and that end user at that time of evaluation. For example, SIML Environment 310 may produce ten classifiers for an individual user's domestic wire transfer activity. Real-time scoring environment 320 may select a unique optimal classifier from among those ten classifiers and may apply it against that user's domestic wire transfer activity to generate a Boolean value indicating whether that user's domestic wire transfer activity should pass or fail. As disclosed herein, specificity can be used to detect fraudulent, bad activity and sensitivity can be used to detect normal, good activity. This sole classifier may optimize at specificity, at sensitivity, or both, depending upon user/client configuration.

In some embodiments, two classifiers could be selected—one that performs the best at specificity and one that performs the best at sensitivity. As a specific example, to decide whether to pass a particular user activity, one or both classifiers may need to pass. In some embodiments, all ten classifiers could be run against the user activity. In this case, a combination of Boolean values from all ten classifiers (e.g., a percentage of pass) may be used to determine whether to pass or fail the user activity.

There's a continuum between sensitivity and specificity. One might prefer optimization of the two, whatever the best one of the two is. In the field of online banking, it may be important not to overly inconvenience end users. For that reason, although classifier(s) may be chosen along that continuum, online banking embodiments may lean towards sensitivity. Other applications such as testing the presence of a certain disease might prefer specificity.

Classifiers may change over time. Thus, in some embodiments, they may be run back through SIML Environment 310 in response to new behavior. This updating process can be the same as the training process described above. That is, behavioral aspects from the collected data may be mapped in real time onto the Modeled Action stage having orthogonal behavioral models. Outputs from the Modeled Action stage may then be trained and tested as described above. This way, the classifiers may dynamically change with each end user's behavior.

In some embodiments, for new users or those having very little activity, it may still be possible to build classifiers to score their behavior. More specifically, users in system 200 may belong to different levels or layers in a hierarchy of an entire financial institution. For example, a bank may have different customer layers such as an entry level customer layer, a preferred customer layer, a commercial customer layer, etc. Or the bank may have a global hierarchy with regional hierarchies. In this way, system 200 may back up on hierarchical level(s) until it has sufficient historical data (e.g., banking customers at one region versus another region) to build classifiers for a new user.

Embodiments disclosed herein therefore can provide a new solution to traditional security and cryptography based identity validation/authentication. Specifically, individual transactions are modeled and prior behavior can be analyzed to determine whether or not certain actions that an end user is taking or trying to do are normal (expected) or abnormal (unexpected) based on that user's prior behavior. This knowledge can be natively integrated into an online banking platform to allow for significantly more secured transactions with very little convenience tradeoff. Since embodiments disclosed herein can detect individual abnormal behavior in real time directly from end user interactions on a transaction by transaction, login by login basis, fraudulent actions or events may be detected at the point of time of initiation and/or stopped before money is moved, preventing illegitimate entities from causing financial harm to a legitimate account holder as well as the financial institution that services the account.

Although the foregoing specification describes specific embodiments, numerous changes in the details of the embodiments disclosed herein and additional embodiments will be apparent to, and may be made by, persons of ordinary skill in the art having reference to this description. In this context, the specification and figures are to be regarded in an illustrative rather than a restrictive sense, and all such modifications are intended to be included within the scope of this disclosure. Accordingly, the scope of the present disclosure should be determined by the following claims and their legal equivalents.

What is claimed is:

1. A method, comprising:
at a computer implementing a risk modeling system, operating two distinct environments, wherein the two distinct environments comprise a real-time scoring environment and a supervised, inductive machine learning environment;
in the supervised, inductive machine learning environment:
partitioning user activity data into a test partition and a train partition;
mapping data from the train partition to a plurality of modeled action spaces to produce a plurality of atomic elements, wherein each of the plurality of atomic elements is associated with a particular user action;
generating classification objects based on behavioral patterns extracted from the plurality of atomic elements;
testing the classification objects utilizing data from the test partition; and
storing an array of distinct classification objects associated with the particular user action in a database;
in the real-time scoring environment:
collecting real-time user activity data during an online transaction;
producing a real-time atomic element representing the particular user action taken by an entity during the online transaction;
applying a classification object to the real-time atomic element representing the particular user action, wherein the classification object is selected from the array of distinct classification objects stored in the database; and
based at least in part on a value produced by the classification object, determining whether to pass or fail the particular user action taken by the entity during the online transaction.

2. The method according to claim 1, wherein determining whether to pass or fail the particular user action taken by the entity during the online transaction is additionally based in part on a sensitivity configuration setting.

3. The method according to claim 1, wherein the classification object fails the particular user action taken by the entity during the online transaction and wherein the particular user action taken by the entity during the online transaction involves moving or transferring money from an account, further comprising:
flagging the particular user action in real-time; and
notifying, in real-time, a legitimate holder of the account, a financial institution servicing the account, or both.

4. The method according to claim 3, further comprising:
preventing the money from being moved or transferred from the account.

5. The method according to claim 1, wherein determining whether to pass or fail the particular user action taken by the entity during the online transaction is additionally based in part on a result produced by a policy engine.

6. The method according to claim 2, wherein the policy engine runs on the real-time user activity data collected during the online transaction.

7. The method according to claim 1, wherein testing the classification objects in the supervised, inductive machine learning environment further comprises:
mapping data from the test partition to the plurality of modeled action spaces; and
applying a classification object associated with the particular user action against an atomic element representing the particular user action.

8. The method according to claim 1, wherein the particular user action is a login activity, a transactional activity, or a traverse activity.

9. The method according to claim 8, wherein the traverse activity comprises traversing an online financial application through an approval path for moving or transferring money.

10. A computer program product comprising at least one non-transitory computer readable medium storing instructions translatable by at least one processor to perform:
partitioning user activity data into a test partition and a train partition;
mapping data from the train partition to a plurality of modeled action spaces to produce a plurality of atomic elements, wherein each of the plurality of atomic elements is associated with a particular user action;
generating classification objects based on behavioral patterns extracted from the plurality of atomic elements;
testing the classification objects utilizing data from the test partition;
storing an array of distinct classification objects associated with the particular user action in a database;
collecting real-time user activity data during an online transaction;
producing a real-time atomic element representing the particular user action taken by an entity during the online transaction;
applying a classification object to the real-time atomic element representing the particular user action, wherein the classification object is selected from the array of distinct classification objects stored in the database; and
based at least in part on a value produced by the classification object, determining whether to pass or fail the particular user action taken by the entity during the online transaction.

11. The computer program product of claim 10, wherein the classification object fails the particular user action taken by the entity during the online transaction, wherein the particular user action taken by the entity during the online transaction involves moving or transferring money from an account, and wherein the instructions are translatable by the at least one processor to perform:
flagging the particular user action in real-time; and
notifying, in real-time, a legitimate holder of the account, a financial institution servicing the account, or both.

12. The computer program product of claim 11, wherein the instructions are translatable by the at least one processor to perform:
preventing the money from being moved or transferred from the account.

13. The computer program product of claim 10, wherein the instructions are translatable by the at least one processor to perform:
mapping data from the test partition to the plurality of modeled action spaces; and
applying a classification object associated with the particular user action against an atomic element representing the particular user action.

14. A system, comprising:
a behavioral analysis engine operating on a computer having access to a production database storing user activity data, wherein the behavioral analysis engine is configured to perform:
in a supervised, inductive machine learning environment:
partitioning user activity data into a test partition and a train partition; a production database storing raw user activity data;
mapping data from the train partition to a plurality of modeled action spaces to produce a plurality of atomic elements, wherein each of the plurality of atomic elements is associated with a particular user action;
generating classification objects based on behavioral patterns extracted from the plurality of atomic elements;
testing the classification objects utilizing data from the test partition; and
storing an array of distinct classification objects associated with the particular user action in a database;
in a real-time scoring environment:
collecting real-time user activity data during an online transaction;
producing a real-time atomic element representing the particular user action taken by an entity during the online transaction;
applying a classification object to the real-time atomic element representing the particular user action, wherein the classification object is selected from the array of distinct classification objects stored in the database; and
based at least in part on a value produced by the classification object, determining whether to pass or fail the particular user action taken by the entity during the online transaction.

15. The system of claim 14, wherein determining whether to pass or fail the particular user action taken by the entity during the online transaction is additionally based in part on a sensitivity configuration setting.

16. The system of claim 15, wherein when the classification object fails the particular user action taken by the entity during the online transaction and the particular user action taken by the entity during the online transaction involves moving or transferring money from an account, the behavioral analysis engine is further configured to perform:
flagging the particular user action in real-time; and
notifying, in real-time, a legitimate holder of the account, a financial institution servicing the account, or both.

17. The system of claim 14, wherein the behavioral analysis engine is further configured to perform:
preventing the money from being moved or transferred from the account.

18. The system of claim 14, wherein the behavioral analysis engine is further configured to perform:
mapping data from the test partition to the plurality of modeled action spaces; and
applying a classification object associated with the particular user action against an atomic element representing the particular user action.

19. The system of claim 14, wherein the particular user action is a login activity, a transactional activity, or a traverse activity.

20. The system of claim 19, wherein the traverse activity comprises traversing an online financial application through an approval path for moving or transferring money.
